(19) United States
(12) Patent Application Publication
(10) Pub. No.: US 2017/0261403 A1
(43) Pub. Date: Sep. 14, 2017

(54) ABNORMALITY DETECTION PROCEDURE DEVELOPMENT APPARATUS AND ABNORMALITY DETECTION PROCEDURE DEVELOPMENT METHOD

(71) Applicant: HITACHI, LTD., Tokyo (JP)

(72) Inventors: Tomoaki HIRUTA, Tokyo (JP); Takayuki UCHIDA, Tokyo (JP); Shigetoshi SAKIMURA, Tokyo (JP); Takahiro FUJISHIRO, Tokyo (JP)

(21) Appl. No.: 15/509,573

(22) PCT Filed: Sep. 1, 2015
(86) PCT No.: PCT/JP2015/074831

§ 371 Date: Mar. 8, 2017

(30) Foreign Application Priority Data
Sep. 9, 2014 (JP) 2014-183084

(51) Int. Cl. G01M 15/14

(52) U.S. Cl. CPC G01M 15/14

(57) ABSTRACT

An abnormality detection procedure development apparatus (10) includes: a parameter setting unit (14) that sets a parameter verification range, with respect to the parameter relating to abnormality determination which is included in an abnormality detection procedure for a mechanical apparatus; an evaluation unit (15) that causes the value of the parameter to be changed in the parameter verification range, and, with respect to each of the values of the parameter that are changed, evaluates abnormality detection performance of the abnormality detection procedure; and a display unit (19) on which a performance evaluation table that is a listing of abnormality detection performances which are evaluated by the evaluation unit (15) is displayed with respect to each of the values of the parameter.

### TECHNICAL FIELD

The present invention relates to an abnormality detection procedure development apparatus and an abnormality detection procedure development method that support development of an abnormality detection procedure for a mechanical apparatus.

### BACKGROUND ART

A mechanical apparatus for social infrastructure, such as a turbine for power generation, is required to run for 24 hours per day. In order to maintain a high operating rate of the mechanical apparatus, an unplanned interruption of the mechanical apparatus has to be prevented. In order to do this, there is a need for transition from periodic maintenance that is based on the operating time for a mechanical apparatus in the related art to state monitoring maintenance that suitably performs preventive maintenance based on a state of the mechanical apparatus. In order to realize the state monitoring maintenance, it is important for the state monitoring apparatus to play the role of analyzing operating data which is collected through various sensors that are installed in the mechanical apparatus, according to a predetermined abnormality detection procedure, and of diagnosing an indication of abnormality or a failure of the mechanical apparatus. At this point, the abnormality detection procedure refers to a flow of processing by a computer that processes data which is acquired from one or more sensors and diagnoses the indication and the like of the abnormality of the mechanical apparatus based on a result of the processing.

Incidentally, in order to improve the precision with which the state monitoring apparatus diagnoses the indication of the abnormality of the mechanical apparatus, it is important that the abnormality detection procedure which is used for the diagnosis of the indication is continuously periodically updated in such a manner as to decrease the number of false positives or false negatives on the diagnosis of the indication. It is noted that the false positive refers to a case where a normal state of the mechanical apparatus is diagnosed as being abnormal and that the false negative refers to a case where an abnormal state of the mechanical apparatus is diagnosed as being normal.

In PTL 1, as an example of a technology that develops the abnormality detection procedure for a mechanical system, the following method for creating a uniform quality evaluation of a turbine mechanical system and a system similar to this and for providing an automatic failure diagnosis tool is disclosed: “A process that operates in a computer creates a mechanical unit signature, a mechanical side signature, and a mechanical fleet signature and keeps track of these signatures (refer to blocks 110 and 120 in FIG. 1), evaluates various operation phenomena (refer to blocks 140 and 150 in FIG. 1), and provides failure detection (refer to blocks 130 and 160 in FIG. 1). The operating data that is collected from the mechanical system in the operation phenomenon is converted in a manner that compensates for or decreases data variance which is caused by an ambient condition and fuel quality. Conversion data is analyzed using a statistical method to determine whether the operation phenomenon is consistent with an expected normal operation. This information is used for creating a single comprehensive quality evaluation of the phenomenon. By saving, keeping track of, and further updating the operation phenomenon evaluation over time, degradation of a mechanical/constituent element is recognized in an arbitrary earlier stage.”

### CITATION LIST

### Patent Literature

PTL 1: JP-A-2005-339558

### SUMMARY OF INVENTION

### Technical Problem

The technology that is disclosed in PTL 1 leads to a so-called optimization problem that adjustment is automatically made until a compensation parameter for compensating the data variance that is caused by the ambient condition and the fuel quality for the mechanical system, a threshold for a quality evaluation category, and a detection algorithm are to be automatically adjusted until a required performance is satisfied (refer to FIG. 3 and FIG. 4 in PTL 1).

However, when it comes to the optimization problem in the detection of the abnormality of the mechanical system, because a function indicating an index for optimization depends on various variables or parameters, there is a limitation on the automatic adjustment of the various variables or parameters using only an optimization algorithm. Accordingly, it is indispensable to utilize expert's domain knowledge (expert knowledge) of the mechanical apparatus and to make an adjustment manually, but in a case where the number of parameters to be adjusted is great, it takes working hours even for an expert on the mechanical apparatus to develop the abnormality detection procedure.

An object of the present invention, which was made to solve the technical problems in the related art, is to provide an abnormality detection procedure development apparatus and an abnormality detection procedure development method that can reduce working hours that it takes for development and is capable of developing an abnormality detection procedure that has a high detection performance.

### Solution to Problem

According to an aspect of the present invention, there is provided an abnormality detection procedure development apparatus, including: a parameter setting unit that sets a parameter verification range that is a range where a value of a parameter is changed, based on data that is input by a user, with respect to the parameter relating to abnormality determination which is included in an abnormality detection procedure for a mechanical apparatus; an evaluation unit that causes the value of the parameter to be changed in the parameter verification range, and, with respect to each of the values of the parameter that are changed, evaluates abnormality detection performance of the abnormality detection procedure; and a display unit on which a performance evaluation table that shows abnormality detection performances which are evaluated by the evaluation unit is displayed with respect to each of the values of the parameter.

### Advantageous Effects of Invention

According to the present invention, there are provided an abnormality detection procedure development apparatus and an abnormality detection procedure development method that can reduce working hours that it takes for development and is capable of developing an abnormality detection procedure that has a high detection performance.

### BRIEF DESCRIPTION OF DRAWINGS

FIG. 1 is a diagram illustrating a flow of information between a mechanical apparatus, a state monitoring apparatus, and an abnormality detection procedure development apparatus according to an embodiment of the present invention, and an example of activities that are performed by a maintenance engineer, an administrator, and an expert.

FIG. 2 is a diagram illustrating an example of a functional configuration of the abnormality detection procedure development apparatus according to the embodiment of the present invention.

FIG. 3 is a diagram illustrating an example of a configuration of abnormality detection procedure information that is stored in an abnormality detection procedure storage unit.

FIG. 4 is a diagram illustrating an example of a configuration of operating information that is stored in an operating data storage unit.

FIG. 5 is a diagram illustrating an example of an abnormality detection procedure development screen that is displayed on a display device through a display unit.

FIG. 6 is a diagram illustrating an example of a parameter verification screen that is displayed on the display device through the display unit.

FIG. 7 is a diagram illustrating an example of a flow of processing by an evaluation unit.

FIG. 8 is a diagram illustrating an example of a flow of processing by a reflection unit.

FIG. 9 is a diagram illustrating an example of a flow of processing by a performance target value setting unit.

FIG. 10 is a diagram illustrating an example of a flow of processing by a search unit.

FIG. 11 is a diagram illustrating an example of a search result screen that the search unit displays on the display device through the display unit.

### DESCRIPTION OF EMBODIMENTS

Embodiments of the present invention will be described in detail below referring to the drawings.

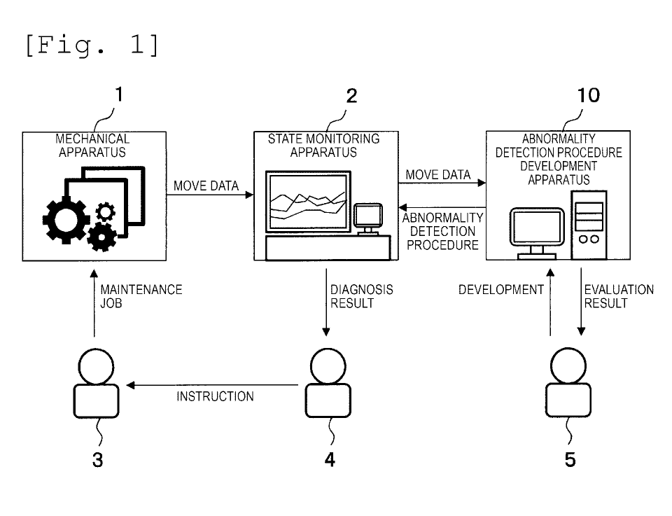

FIG. 1 is a diagram illustrating a flow of information between a mechanical apparatus 1, a state monitoring apparatus 2, and an abnormality detection procedure development apparatus 10 according to an embodiment of the present invention, and an example of activities that are performed by a maintenance engineer 3, an administrator 4, and an expert 5.

The mechanical apparatus 1 is an apparatus that is a target which is monitored by the state monitoring apparatus 2. The mechanical apparatus 1 is a target for a maintenance job that is performed by the maintenance engineer 3, periodically or when an abnormality or an indication of an abnormality (which is referred to simply as an abnormality) is detected by the state monitoring apparatus 2. Various sensors (not illustrated) are mounted in the mechanical apparatus 1, and various pieces of state data of the mechanical apparatus 1, which are measured by the various sensors, are output, as pieces of operating data, toward the state monitoring apparatus 2. It is noted that any apparatus that realizes an expected function by an accompanying mechanical operation may serve as the mechanical apparatus 1.

The state monitoring apparatus 2 is configured with a display device that is not illustrated, a console, a control computer, and the like, and is connected to the mechanical apparatus 1 and the abnormality detection procedure development apparatus 10 through a wired or wireless communication system. The state monitoring apparatus 2 collects the operating data from the mechanical apparatus 1, accumulates the data, in addition, diagnoses periodically the presence and absence of the abnormality in the mechanical apparatus 1 according to a prescribed abnormality detection procedure, and reports a result of the diagnosis to the administrator 4. Based on the reporting of the result of the diagnosis from the state monitoring apparatus 2, when noticing an abnormality of the mechanical apparatus 1, the administrator 4 instructs the maintenance engineer 3 in a work site to perform an operation of maintaining the mechanical apparatus 1.

The abnormality detection procedure development apparatus 10 is configured with a personal computer or a workstation, and supports development of the abnormality detection procedure for the mechanical apparatus 1 by the expert 5. That is, the expert 5 develops the abnormality detection procedure for the mechanical apparatus 1, using the operating data for evaluation which are acquired from the state monitoring apparatus 2, or utilizing his/her own domain knowledge (an expert knowledge). At this point, the abnormality detection procedure development apparatus 10 has an evaluation means of evaluating the abnormality detection procedure that is developed by the expert 5, and reports a result of the evaluation by the evaluation means to the expert 5.

It is noted that the expert 5, for example, refers to a developer or a designer of the mechanical apparatus 1, and a person who has ample experience in development or design, a management, and maintenance of a similar mechanical apparatus.

As described above, the abnormality detection procedure for the mechanical apparatus 1, which is developed by the expert 5 and is evaluated, is sent from the abnormality detection procedure development apparatus 10 to the state monitoring apparatus 2, and is used, in the state monitoring apparatus 2, for monitoring (abnormality detection) of the mechanical apparatus 1.

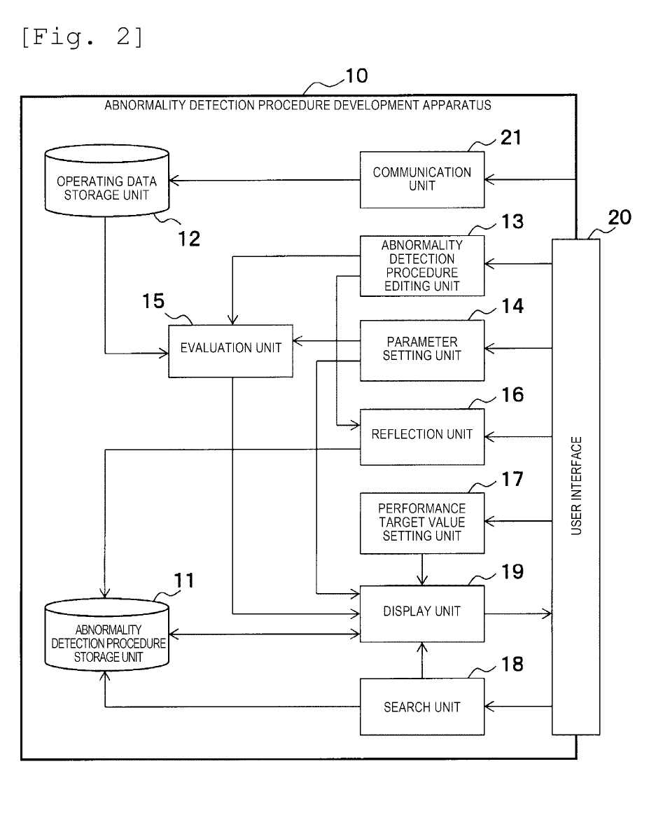

FIG. 2 is a diagram illustrating an example of a functional configuration of the abnormality detection procedure development apparatus 10 according to the embodiment of the present invention. As illustrated in FIG. 2, the abnormality detection procedure development apparatus 10 is configured with a so-called computer which includes an abnormality detection procedure storage unit 11, an operating data storage unit 12, an abnormality detection procedure editing unit 13, a parameter setting unit 14, an evaluation unit 15, a reflection unit 16, a performance target value setting unit 17, a search unit 18, a display unit 19, a user interface 20, a communication unit 21, and the like. Furthermore, the abnormality detection procedure development apparatus 10 as hardware includes an arithmetical-operation processing device (a microprocessor), which is not illustrated, a storage device (a semiconductor memory, a hard disk, or the like), and an input/output device (a keyboard, a mouse, a display device, a communication device, or the like).

At this point, a function of each of the abnormality detection procedure editing unit 13, the parameter setting unit 14, the evaluation unit 15, the reflection unit 16, the performance target value setting unit 17, the search unit 18, the display unit 19, and the communication unit 21 is realized by the arithmetical-operation processing device executing a prescribed program that is stored in the storage device. Furthermore, the abnormality detection procedure storage unit 11 and the operating data storage unit 12 are each configured by a storage device storing prescribed data. Furthermore, it is assumed that the user interface 20 includes a keyboard, a mouse, a liquid crystal display device, and the like, and further includes a control program therefor. A user can exchange data among the abnormality detection procedure editing unit 13, the parameter setting unit 14, the reflection unit 16, the performance target value setting unit 17, the search unit 18, and the display unit 19, through the user interface 20.

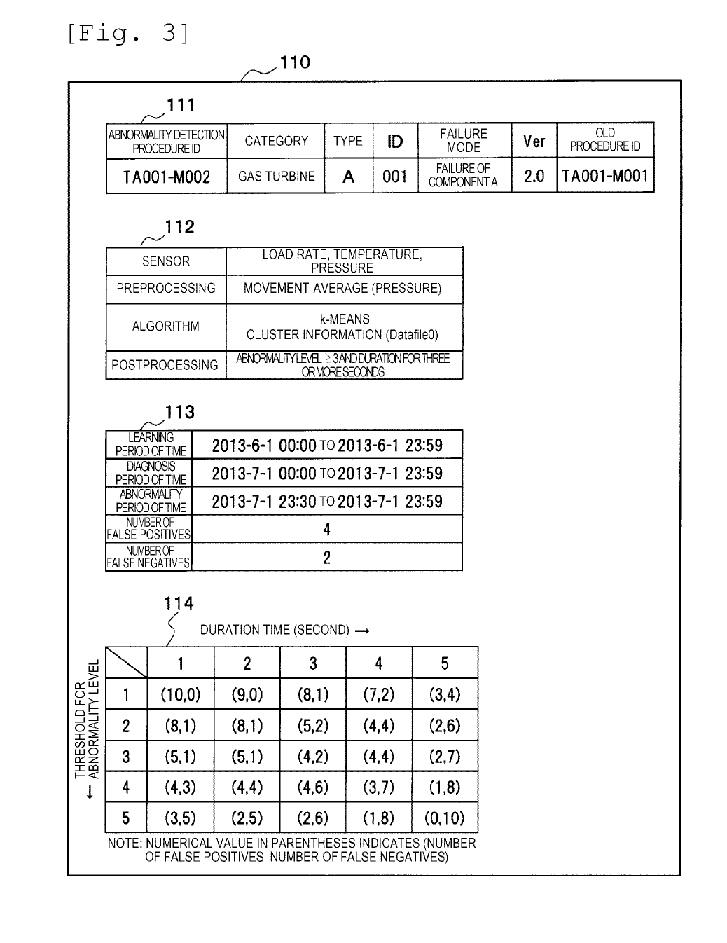

FIG. 3 is a diagram illustrating an example of a configuration of abnormality detection procedure information 110 that is stored in the abnormality detection procedure storage unit 11 (refer to FIG. 2). As illustrated in FIG. 3, the abnormality detection procedure information 110 that is stored in the abnormality detection procedure storage unit 11 is configured to include header information 111, procedure information 112, evaluation information 113, and parameter verification result information 114. Configurations of these pieces of information are described in detail sequentially.

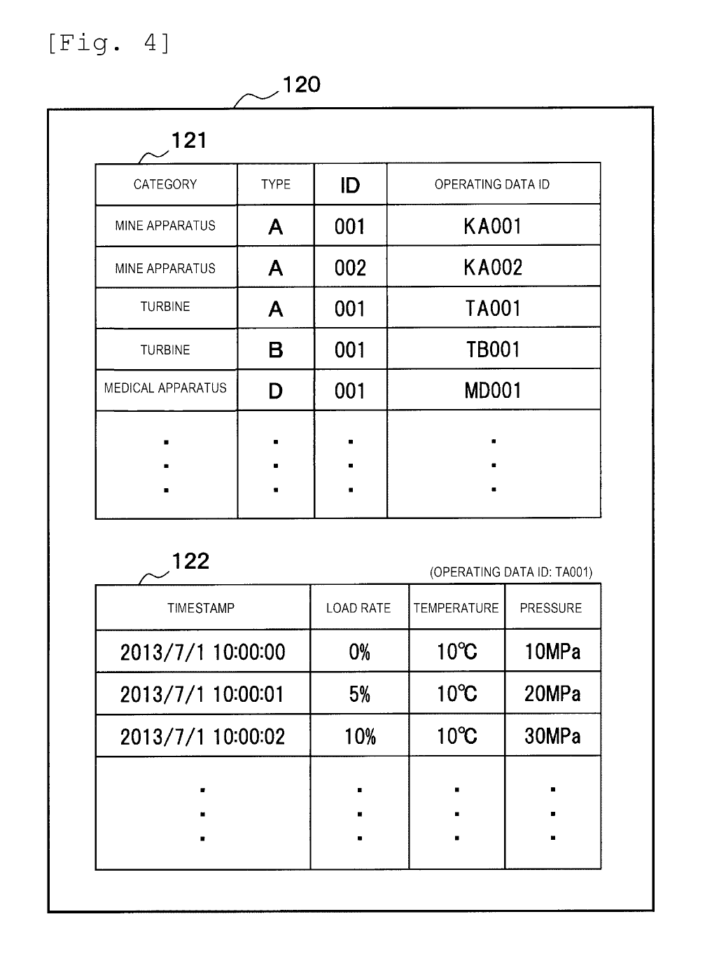

As illustrated in FIG. 3, the header information 111 is configured to include pieces of data, such as an “abnormality detection procedure ID,” a “category,” a “type,” an “ID,” a “failure mode,” a “version (Ver),” an “old procedure ID,” and the like. At this point, pieces of data, such as the “category,” the “type,” and the “ID,” are pieces of data indicating a type, a model, a manufacturing number, and the like of the mechanical apparatus 1, and are pieces of data that are obtained from a machine table 121 (refer to FIG. 4) which is stored in the operating data storage unit 12.

Furthermore, the “abnormality detection procedure ID” is an identification number for identifying an abnormality detection procedure that is indicated by the abnormality detection procedure information 110, (which is hereinafter referred to simply as the abnormality detection procedure), the “failure mode” is a name of a failure that is a target which is to be detected with the current abnormality detection procedure, and the “version” is the number of times that the abnormality detection procedure is updated. Furthermore, the “old procedure ID” is information for specifying the abnormality detection procedure information 110 that is the immediately-preceding version of a current abnormality detection procedure information 110. Therefore, the “abnormality detection procedure ID” of the abnormality detection procedure information 110, which is stored in the abnormality detection procedure storage unit 11, is searched for with the “old procedure ID” as a key, and thus the immediately-preceding version of the abnormality detection procedure information 110 can be acquired.

It is noted that the abnormality detection procedure information 110 is individually created for every “type” or “ID” of the mechanical apparatus 1, and further for every “failure mode.” That is, the header information 111 can be said to be information for identifying the abnormality detection procedure that is indicated by the abnormality detection procedure information 110 in which the header information 111 itself is included.

Furthermore, as illustrated in FIG. 3, the procedure information 112 is configured to include “sensor” information, “preprocessing” information, “algorithm” information, and “postprocessing” information, and the like, and is information indicating specified contents of the abnormality detection procedure.

At this point, as the “sensor” information in the procedure information 112, names of one or more sensors that are used in the abnormality detection procedure, or names of pieces of data that are acquired by the one or more sensors are set. It is noted that a load rate, a temperature, and a pressure are set as the “sensor” information in an example in FIG. 3.

Furthermore, as the “preprocessing” information in the procedure information 112, conversion processing of sensor data and a state separation condition are set. The conversion processing of the sensor data refers to processing that is performed on the sensor data which is acquired through the sensor before applying a diagnosis algorithm. For example, the conversion processing of the sensor data refers to filtering processing for noise removal or movement averaging processing. Furthermore, the state separation condition refers to a condition that defines a steady state of the mechanical apparatus 1.

It is noted that, in the example in FIG. 3, an example of performing the movement averaging processing on the sensor data that indicates a pressure is illustrated as the conversion processing the sensor data. On the other hand, in FIG. 3, an example of the state separation condition is not particularly illustrated. The state separation condition will be described supplementarily below.

Generally, a state of the mechanical apparatus 1 is divided into a steady state in which the mechanical apparatus 1 operates in a stabilized manner, and a transient state before the steady state is reached. For example, an engine, which is not sufficiently warmed up immediately after starting, is in the transient state of not operating in a stabilized manner during that, but when a fixed period of time has elapsed, is in the steady state of operating in a stabilized manner. Therefore, when the state of the mechanical apparatus 1 is not separated into the steady state and the transient state, that is, when the abnormality of the mechanical apparatus 1 is diagnosed using all pieces of data on the mechanical apparatus 1, many false positives on the results of the diagnosis occur due to instability of the operation in the transient state. In contrast, when the abnormality of the mechanical apparatus 1 is diagnosed by separating the operating data in the steady state from among pieces of operating data on the mechanical apparatus 1 and using the separated operating data, the number of false positive is reduced, and thus precision of the result of the abnormality diagnosis can be improved in the mechanical apparatus 1.

This extraction of the steady state of the mechanical apparatus 1 is referred to as state separation. Accordingly, according to the present embodiment, the state separation condition is set using a sensor or data that is obtained from the sensor as information of the state separation condition. For example, as a state separation condition for extracting a steady state of the engine, a condition that a temperature of engine oil be equal to or higher than 60 degrees, for example, is set.

Furthermore, as the “algorithm” information in the procedure information 112, a name of an algorithm for determining the abnormality of the mechanical apparatus 1 and parameter information that is used for the algorithm are set. In the example in FIG. 3, cluster information is stored in a data file (Datafile 0) with the name of the algorithm as a “k-means” and the parameter information as the cluster information.

It is noted that, an algorithm for abnormality determination is not limited to a cluster analysis that uses the “k-means,” and may be a “main component analysis,” or the like.

Furthermore, as the “postprocessing” information in the procedure information 112, condition data for the abnormality determination that is used in processing which determines the abnormality of the mechanical apparatus 1, which results after applying the diagnosis algorithm, is set. In the example in FIG. 3, as the condition data for the abnormality determination, the keeping of higher than an abnormality level that is equal to or greater than 3, for three seconds or longer is set.

In a general cluster analysis, if the operating data, which is constructed from n pieces of sensor data, is defined as being acquired at every prescribed timestamp, an n-dimensional vector space that has the n pieces of sensor data as components thereof can be assumed. Therefore, the operating data that has n components at every timestamp is divided into clusters in the n-dimensional vector space. Then, in a case where there is operating data that does not belong to any cluster, with the operating data, it is determined that an abnormality, that is, an abnormality or an indication of an abnormality appears of the mechanical apparatus 1.

At this point, in order to determine whether or not the n-dimensional operating data belongs to any one of the clusters, a concept of an abnormality level is introduced. For example, the abnormality level can be defined based on a position that is indicated by the operating data and on a Euclidean distance from the center of the closest cluster to the position. Then, in a case where an abnormality level is at a prescribed threshold or above, it is determined that the operating data that has such an abnormality level is abnormality data that does not belong to any of the clusters.

Incidentally, in the example in FIG. 3, in a case where it is determined that an abnormality occurs when the abnormality level is at a threshold “3” or above, and in a case where the abnormality of the operating data continues for three or more seconds, the case is detected as the abnormality of the mechanical apparatus 1.

Additionally, as illustrated in FIG. 3, the evaluation information 113 is configured to include “learning-period-of-time” information, “diagnosis-period-of-time” information, “abnormality-period-of-time” information, “number-of-erroneous-reports” information, “number-of-failing-reports” information, and the like, and is information that indicates a result of evaluating the abnormality detection procedure.

In a case where an algorithm that is designated with the “algorithm” information in the procedure information 112 is machine learning, as the “learning-period-of-time” information, a period for which the learning is performed is set. In an example of the evaluation information 113 in FIG. 3, the “learning-period-of-time” is from 00:00 June 1, 2013 to 23:59 June 1, 2013.

As the “diagnosis-period-of-time” information, a period of time for which the number of false positives and the number of false negatives are evaluated are set. In the example of the evaluation information 113 in FIG. 3, the “diagnosis period of time” is from 00:00 July 1, 2013 to 23:59 July 1, 2013.

As the “abnormality-period-of-time” information, a period of time for which the mechanical apparatus 1 within the “diagnosis period of time” is abnormal is set. In the example of the evaluation information 113 in FIG. 3, the “abnormality period of time” is from 23:30 July 1, 2013 to 23:59 July 1, 2013.

Furthermore, as a result of evaluating an abnormality detection result which is determined on the operating data during the “diagnosis period of time” by the “postprocessing” in the procedure information 112, the number of cases where a normal state is erroneously determined as abnormality detection and the number of cases where an abnormal state occurs but is overlooked, are stored under the headings of “number of false positives and “number of false negatives, respectively. In the example of the evaluation information 113 in FIG. 3, the “number of false positives” is 4, and the “number of false negatives” is 2.

It is noted that, at this point, the false positive and the false negative are expressed in number of cases, but, for example, may be expressed with a total of duration times of the false positive and a total of duration times of the false negative, respectively.

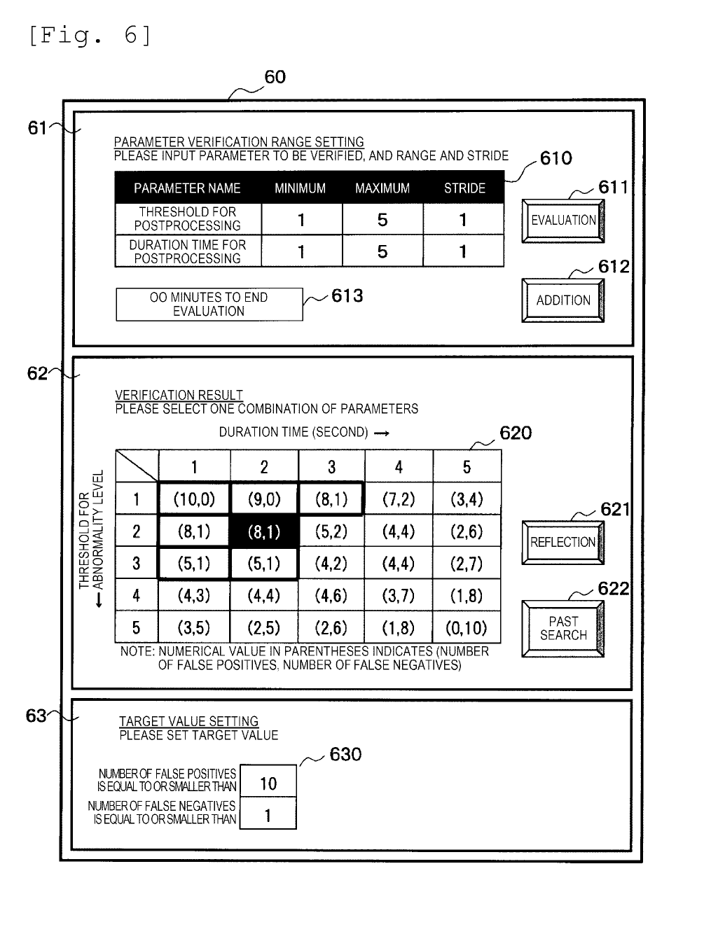

Additionally, as illustrated in FIG. 3, the parameter verification result information 114 is information that indicates a result of evaluating how the abnormality detection result changes when a parameter is changed in a verification range (refer to FIG. 6) of the parameter that is set in the parameter setting unit 14.

In an example of the parameter verification result information 114 in FIG. 3, as a parameter for a verification target, a threshold for the abnormality level for performing the determination as normality and a duration time when the determination as normality is performed are selected. Then, the abnormality level is changed from 1 to 5 in the row direction, and the duration time is changed from one second to five seconds in the column direction. Furthermore, the number of false positives and the number of false negatives are stored in a box at which a column for the abnormality level that is changed and a row for the duration time that is changed intersects. Incidentally, in a case where a threshold for the abnormality level is 3 and the duration time is three or more seconds, the number of false positives is 4 and the number of false negatives is 2.

It is noted that generally, when a value of each of these parameters is increased, because the abnormality is difficult to catch, the number of false positives decreases and the number of false negatives increases. On the other hand, when the value of the parameter is decreased, because the abnormality is easy to catch, the number of false positives increases and the number of false negatives decreased.

FIG. 4 is a diagram illustrating an example of a configuration of operating information 120 that is stored in the operating data storage unit 12 (refer to FIG. 2). As illustrated in FIG. 4, the operating information 120 is configured to include the machine table 121 and an operating data 122.

The machine table 121 is configured with pieces of data, such as “category,” “type,” “ID,” and “operating data ID,” and designates the mechanical apparatus 1 that is a diagnosis target and the operating data 122 that is acquired from the mechanical apparatus 1. At this point, the “category,” the “type,” and the “ID” have the same meanings as the “category,” the “type,” and the “ID” that are referred to in the header information 111 in the abnormality detection procedure information 110 which is illustrated in FIG. 3. Furthermore, the “operating data ID” is information for identifying the operating data 122, and, for example, may be a name of a file in which the operating data 122 is stored.

The operating data 122 is created for every mechanical apparatus 1 that is designated with the “category,” the “type,” and the “ID” of the machine table 121. That is, at least one piece of operating data 122 or normally a plurality of pieces of operating data 122 are stored in one operating data storage unit 12.

Furthermore, as illustrated in FIG. 4, the operating data 122 is configured by associating sensor data that is acquired from a sensor which is mounted in each of the mechanical apparatuses 1, with a timestamp at which the sensor data is acquired. Normally, the sensor data is acquired with a predetermined periodicity (for example, a periodicity of one second).

It is noted that in the operating data 122 in an example in FIG. 4, pieces of sensor data, such as a load rate, a temperature, and a pressure are acquired with every periodicity of one second. Furthermore, because an operating data ID of the operating data 122 is TA001, if the machine table 121 is referred to, it is understood that the operating data 122 in the machine table 121 is acquired from the mechanical apparatus 1, of which “category” is “turbine,” of which “type” is “A,” and of which “ID” is “001.” It is noted that an item of sensor data in the operating data 122 may differ according to each of the mechanical apparatus 1.

A description is provided referring back to FIG. 2.

The communication unit 21 is connected to the state monitoring apparatus 2 through a wired or wireless communication system (not illustrated), and is connected to the mechanical apparatus 1 through the state monitoring apparatus 2 (refer to FIG. 1). Then, among pieces of operating data on the mechanical apparatus 1, which are collected by the state monitoring apparatus 2, the communication unit 21 acquires operating data 122 on the mechanical apparatus 1 that is a verification target, from the state monitoring apparatus 2 and stores the acquired operating data 122 in the operating data storage unit 12. Furthermore, the communication unit 21 transmits the procedure information 112 (refer to FIG. 3) that is stored in the abnormality detection procedure storage unit 11, to the state monitoring apparatus 2 that is connected to the mechanical apparatus 1 that is the verification target.

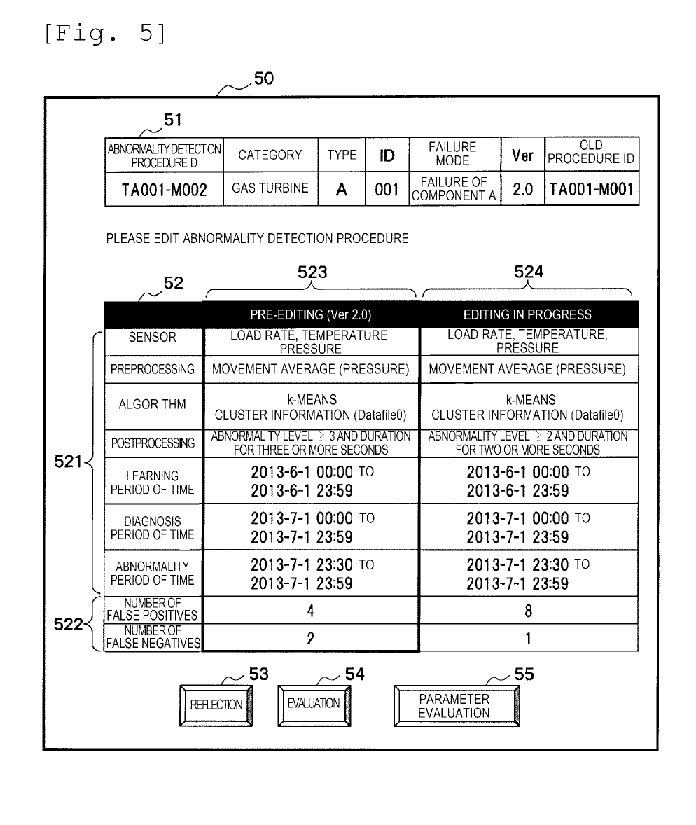

The abnormality detection procedure editing unit 13 receives input of the abnormality detection procedure ID that is input through the user interface 20, and reads the abnormality detection procedure information 110 that is designated with the abnormality detection procedure ID, from the abnormality detection procedure storage unit 11. Then, based on the abnormality detection procedure information 110 that is read, the abnormality detection procedure editing unit 13 displays an abnormality detection procedure development screen 50 on the display device through the display unit 19, as is next illustrated in FIG. 5.

At this point, in a case where the abnormality detection procedure information 110 that corresponds to the abnormality detection procedure ID is not stored in the abnormality detection procedure storage unit 11, new development of the abnormality detection procedure is assumed. In a case where the abnormality detection procedure information 110 is stored in the abnormality detection procedure storage unit 11, update of the abnormality detection procedure is assumed.

FIG. 5 is a diagram illustrating an example of the abnormality detection procedure development screen 50 that is displayed on a display device through the display unit 19. As illustrated in FIG. 5, header information 51, abnormality detection procedure editing information 52, a “reflection” button 53, an “evaluation” button 54, and a “parameter evaluation” button 55 are displayed on the abnormality detection procedure development screen 50.

The header information 51 is the same as the header information 111 that is illustrated in FIG. 3. Furthermore, the abnormality detection procedure editing information 52 is configured with pre-editing data 523 and editing-in-progress data 524 that have the same item names as the procedure information 112 and the evaluation information 113 that are illustrated in FIG. 3. At this point, in the case of the new development of the abnormality detection procedure, the pre-editing data 523 and the editing-in-progress data 524 are both unavailable. On the other hand, in the case of the update of the abnormality detection procedure, the editing-in-progress data 524 is unavailable, but pieces of data that are the same as the procedure information 112 and the evaluation information 113 in the abnormality detection procedure information 110 that is read from the abnormality detection procedure storage unit 11 are shown in a box for the pre-editing data 523.

Among pieces of editing-in-progress data 524, the user (the expert 5) can freely edit editing-target data 521 (data, such as “sensor,” “preprocessing,” “algorithm,” “postprocessing,” “learning period of time,” “diagnosis period of time,” or “abnormality period of time),” through the abnormality detection procedure development screen 50. Then, in an editing task, the pre-editing data 523, as is, may be copied to the editing-in-progress data 524, and a change may be made to a necessary part.

However, at least evaluation result data 522 (the number of false positives and the number of false negatives) in the editing-in-progress data 524 can be neither copied, nor arbitrary edited by the user. The evaluation result data 522 (the number of false positives and the number of false negatives) in the editing-in-progress data 524 is displayed after the evaluation of the abnormality detection procedure is ended in the evaluation unit 15.

Furthermore, in the abnormality detection procedure development screen 50, the “reflection” button 53, the “evaluation” button 54, and the “parameter evaluation” button 55 are buttons that activate the reflection unit 16, the evaluation unit 15, and the parameter setting unit 14, respectively. Accordingly, when the user clicks in the “parameter evaluation” button 55, the parameter setting unit 14 is activated, and the parameter setting unit 14 displays a parameter verification screen 60 (refer to FIG. 6) on the display device through the display unit 19.

FIG. 6 is a diagram illustrating an example of the parameter verification screen 60 that is displayed on the display device through the display unit 19. As illustrated in FIG. 6, the parameter verification screen 60 is configured with a sub-screen 61 for setting a parameter verification range, a sub-screen 62 for displaying a parameter verification result, and a sub-screen 63 for setting a target value of the abnormality detection.

When the parameter setting unit 14 is first activated, only the sub-screen 61 is displayed. Then, a parameter setting table 610, an “evaluation” button 611, an “addition” button 612, and a message 613 that alerts the user to the time to the ending of the evaluation are displayed on the sub-screen 61.

The parameter setting table 610 is a table for setting a range and a stride of parameters that are verification target, and every parameter has the headings of a name of a parameter, a minimum value and a maximum value of the parameter, and a stride. The user appropriately inputs a name or a numerical value under each of the heading in the parameter setting table 610, and thus can set the range and the stride of the parameter that is the verification target.

However, in a case where the abnormality detection procedure development screen 50 (refer to FIG. 5) is for updating the abnormality detection procedure, when it comes to the name of the parameter name, a name of a parameter that is included in the pre-editing data 523 is set.

It is noted that in an example of the parameter setting table 610 in FIG. 6, as the parameter that is the verification target, a threshold and a duration time for the postprocessing are set. Then, a minimum value of the threshold for the postprocessing is an abnormality level of 1, a maximum value thereof is an abnormality level of 5, with the stride of 1. A minimum value of the duration time for the postprocessing is 1 second, a maximum value thereof is 5 seconds, with the stride of 1 second.

Furthermore, on the sub-screen 61, an “addition” button 612 is clicked on, one empty row is appended in the parameter setting table 610. The user can set a name of a new parameter, a maximum value of the parameter, a minimum value of the parameter and a stride, in the empty row.

Furthermore, when the “evaluation” button 611 is clicked on, the evaluation unit 15 is activated. At this time, the evaluation unit 15 causes a value of each parameter to be changed for the range and the stride of the parameter that are set in the parameter setting table 610, and, with respect to all combinations of the parameters, evaluates an abnormality detection performance using an algorithm for the editing-in-progress data 524 on the abnormality detection procedure development screen 50 (refer to FIG. 5). Then, as a result of the evaluation, the number of false positives and the number of false negatives with respect to all combinations of parameters are obtained.

When the evaluation of the evaluation unit 15 by the abnormality detection performance ends, the sub-screen 62 and the sub-screen 63 are displayed on the parameter verification screen 60. Then, a parameter verification result table 620, a “reflection” button 621, and a “past-search” button 622 are displayed on the sub-screen 62. The parameter verification result table 620 shows the number of false positives and the number of false negatives with respect to all combinations of parameters that are obtained by the evaluation unit 15.

Therefore, the parameter verification result table 620 can be said to be a performance evaluation table that shows a listing of abnormality detection performances of the abnormality detection procedures with respect to each of the combinations of the parameters. Furthermore, the parameter verification result table 620 shows the parameter verification result information 114 in the abnormality detection procedure information 110 (refer to FIG. 3).

It is noted that in an example in FIG. 6, because there are two parameters for the verification target, the parameter verification result table 620 is a two-dimensional table, but may be a three- or more-dimensional table. However, in a case where the parameter verification result table 620 is the three- or more-dimensional table, a plurality of two-dimensional tables need to be displayed. In such a case, two parameters can be freely designated, and with the designated parameters, the two-dimensional table may be individually displayed.

Furthermore, a target value input box 630 for the abnormality detection performance is displayed on the sub-screen 63. The target value input box 630 is for narrowing the number of combinations that satisfy a performance which is desired by the user, among combinations of the number of false positives and the number of false negatives that are shown in the parameter verification result table 620 on the sub-screen 62. That is, when target values that are desired by the user are set in the target value input boxes 630, boxes that satisfy the target value in the parameter verification result table 620 on the sub-screen 62 are displayed in an emphasized manner, such as, for example, in a thick-line frame.

In the example in FIG. 6, target values of the number of false positives being equal to or smaller than “10” and of the number of false negatives being equal to or smaller than “1” are set to be in the target value input boxes 630. Furthermore, the parameter verification result table 620 on the sub-screen 62, boxes that satisfy the target value, that is, boxes of combinations (1, 1), (1, 2), (1, 3), (2, 1), (2, 2), (3, 1), and (3, 2) of parameters (abnormality level, duration time) are displayed in a thick-line frame.

Subsequently, the user (the expert 5) selects a parameter that is to be used for the abnormality detection procedure, from among the combinations of parameters that correspond to the boxes which are displayed in an emphasized manner in the parameter verification result table 620. For example, in the example in FIG. 6, the combinations of parameters that satisfy the target value are narrowed to 7 sets, but, from among these, the user (the expert 5) selects one, for example, a combination (2, 2) of (abnormality level, duration time), as a parameter that is used for the abnormality detection procedure.

Because the selection of the parameters is performed by the user (the expert 5), the user (the expert 5) can harness his own domain knowledge. For example, in the example in FIG. 6, the determination itself of the number of false positives and the number of false negatives as “8” and “1,” respectively, from among target values of the number of false positives of equal to or smaller than 10 and target values of the number of false negatives of equal to or smaller than 1, cannot be made without the domain knowledge or the past ample experience of the expert 5. Furthermore, there is three sets of combinations of parameters (abnormality level, duration time) that is, (1, 3), (2, 2), and (2, 1), that satisfy (number of false positives, number of false negatives)=(8, 1), and the selection of (2, 2) among these can be achieved only with the domain knowledge or the past ample experience of the expert 5.

However, even in the case of the expert 5, in a situation where which relationship parameters and a performance of the abnormality detection procedure have is not understood, suitable parameters are difficult to determine. Only after understanding the relationship between the parameters as illustrated in the parameter verification result table 620 and the abnormality detection procedure performance, the expert 5 can determine suitable parameters. That is, the parameter verification result table 620 assists the expert 5 in determining optimal parameters.

In this way, when the user (the expert 5) selects one box from boxes that are displayed in an emphasized manner in the parameter verification result table 620 on the sub-screen 62, the selected box is displayed in emphasized manner. Then, a combination of parameters that corresponds to the box is determined as parameters that are to be used for the abnormality detection procedure. It is noted that in the example in FIG. 6, a box corresponding to a combination of parameters (abnormality level, duration time) being (2,2) is displayed in a manner that appears as white in a black block.

Subsequently, when the user clicks on the “reflection” button 621, parameters (abnormality level, duration time) that the user (the expert 5) determines as being optimal based on the parameter verification result table 620 are reflected in the editing-in-progress data 524 in the abnormality detection procedure editing information 52 in FIG. 5.

Furthermore, when the user clicks on the “past-search” button 622, the search unit 18 is activated, and the search unit 18 displays a search result screen 70 (refer to FIG. 11) on the display device through the display unit 19.

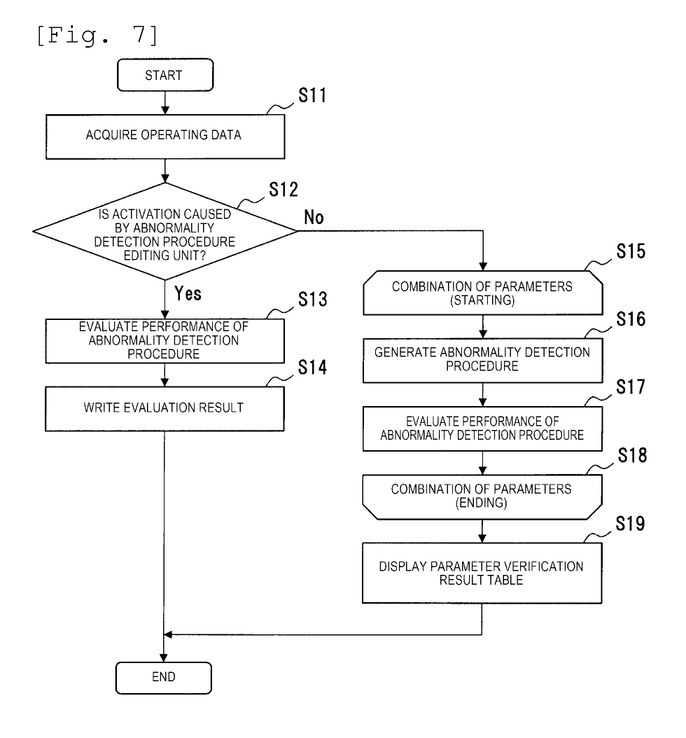

FIG. 7 is a diagram illustrating an example of a flow of processing by the evaluation unit 15. The evaluation unit 15 is activated by the abnormality detection procedure editing unit 13 (the “evaluation” button 54 in FIG. 5) or the parameter setting unit 14 (the “evaluation” button 611 in FIG. 6), and evaluates a performance of the abnormality detection procedure with respect to a combination of parameters that is designated by each of the abnormality detection procedure editing unit 13 and the parameter setting unit 14,

As illustrated in FIG. 7, the evaluation unit 15 first acquires from the operating data storage unit 12 the operating data 122 that is acquired from the mechanical apparatus 1 which is designated with the header information 51 on the abnormality detection procedure development screen 50 (refer to FIG. 5) on which editing is in progress (Step S11). Next, it is determined whether or not the processing by the evaluation unit 15 is activated by the abnormality detection procedure editing unit 13 (the “evaluation” button 54 in FIG. 5) (Step S12).

As a result of the determination, in a case where the processing is activated by the abnormality detection procedure editing unit 13 (the “evaluation” button 54 in FIG. 5) (Yes in Step S12), the evaluation unit 15 evaluates the performance of the abnormality detection procedure that is designated with the editing-in-progress data 524 in FIG. 5, using the operating data 122 that is acquired in Step S11 (Step S13).

At this point, the processing for the evaluation in Step S13 is described in detail, using an example of the editing-in-progress data 524 on the abnormality detection procedure development screen 50 in FIG. 5. Using the operating data 122 that corresponds to the “learning period of time,” the evaluation unit 15 performs cluster analysis that is based on the k-means and generates cluster information. Then, based on an abnormality determination condition for the postprocessing of the editing-in-progress data 524, the evaluation unit 15 diagnoses the operating data 122 that corresponds to the diagnosis period of time and the abnormality period of time, and calculates the number of false positives and the number of false negatives. It is noted that the operating data 122 that correspond to a period of time that results from subtracting the abnormality period of time from the diagnosis period of time is assumed to be normal.

Next, the evaluation unit 15 writes an evaluation result that is obtained with the evaluation in Step S13 to a box for the evaluation result data 522 (number of false positive, number of false negative) in the editing-in-progress data 524 on the abnormality detection procedure development screen 50 in FIG. 5 (Step S14), and ends the processing.

On the other hand, as a result of the determination in Step S12, in a case where the activation is not caused by the abnormality detection procedure editing unit 13 (the “evaluation” button 54 in FIG. 5) (No in Step S12), more precisely, in a case where the activation is caused by the parameter setting unit 14 (the “evaluation” button 611 in FIG. 6), the evaluation unit 15 repeatedly performs processing operations that are interposed between Step S15 and Step S18, that is, repeatedly performs Step S16 and Step S17, with respect to all combinations of parameters that are set using the parameter setting table 610 in FIG. 6.

In the processing operations that are repeatedly performed, the evaluation unit 15 first generates the abnormality detection procedure with respect to a combination of parameters that is designated in the processing (Step S15) that is first repeated (Step S16). Subsequently, the evaluation unit 15 evaluates the performance of the abnormality detection procedure that is generated in Step S16, using the operating data 122 that is acquired in Step S11 (Step S17). It is noted that the processing for the evaluation in Step S17 is basically the same as the processing for the evaluation in Step S13 described above.

Next, the evaluation unit 15 displays a result of evaluating the performance of the abnormality detection procedure, which is obtained with the repeatedly-performed processing operations in Step S16 and Step S17, as the parameter verification result table 620, on the display device (Step S19), and ends the processing.

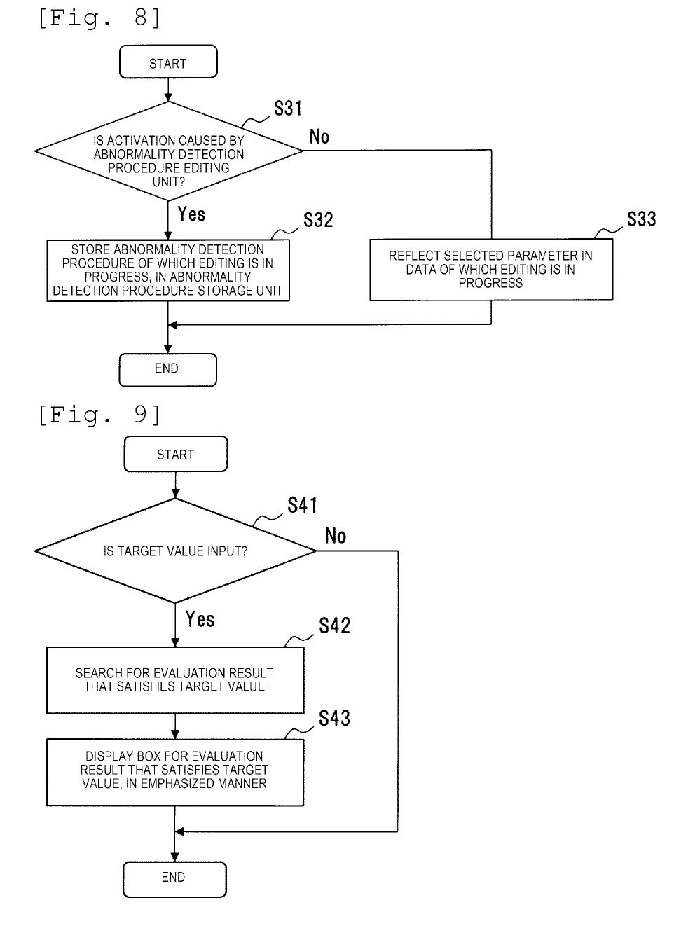

FIG. 8 is a diagram illustrating an example of a flow of processing by the reflection unit 16. The reflection unit 16 is activated by the abnormality detection procedure editing unit 13 (the “reflection” button 53 in FIG. 5) or the parameter setting unit 14 (the “reflection” button 621 in FIG. 6). As illustrated in FIG. 8, the reflection unit 16 first determines whether or not the activation is caused by the abnormality detection procedure editing unit 13 (the “reflection” button 53 in FIG. 5) (Step S31).

As a result of the determination, in a case where the activation is caused by the abnormality detection procedure editing unit 13 (the “reflection” button 53 in FIG. 5) (Yes in Step S31), the reflection unit 16 stores the editing-in-progress data 524 that is data for the abnormality detection procedure, of which the editing is in progress through the abnormality detection procedure development screen 50 (refer to FIG. 5), in the abnormality detection procedure storage unit 11 (Step S32), and ends the processing.

It is noted that at the time of writing to the abnormality detection procedure storage unit 11, the header information 51 is together written, and a box for “Ver” is updated.

On the other hand, in the determination in Step S31, in a case where the activation is not caused by the abnormality detection procedure editing unit 13 (the “reflection” button 53 in FIG. 5) (No in Step S31), more precisely, in a case where the activation is caused by the parameter setting unit 14 (the “reflection” button 621 in FIG. 6), the reflection unit 16 causes a parameter that, at this time, is selected as a parameter which is used for the abnormality detection procedure, to be reflected in the editing-in-progress data 524 on the abnormality detection procedure development screen 50 in FIG. 5 (Step S33), and ends the processing. It is noted that, in the example in FIG. 6, the parameters that are selected as the parameters which are used for the abnormality detection procedure refer to abnormality level=“2” and duration time=“2” seconds, which designate a box that appears as white in a black block.

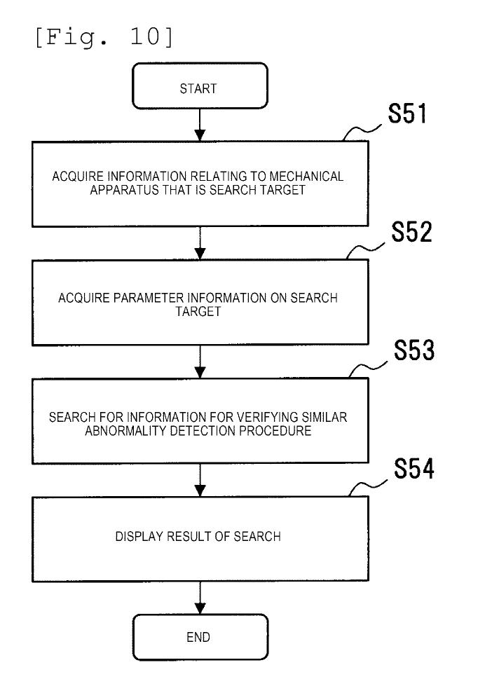

FIG. 9 is a diagram illustrating an example of a flow of processing by the performance target value setting unit 17. As illustrated in FIG. 9, the performance target value setting unit 17 first determines whether or not a target value is input into the target value input box 630 on the sub-screen 63 of the parameter verification screen 60 (refer to FIG. 6) (Step S41), and, in a case where the target value is input (Yes in Step S41), searches evaluation results in all boxes in the parameter verification result table 620, for an evaluation result that satisfies the target value (Step S42). Subsequently, the performance target value setting unit 17 displays a box of the evaluation result that satisfies the target value, which is extracted through the search, for example in an emphasized manner, such as in a thick-line frame (Step S43) and ends the processing.

Furthermore, in a case where as a result of the determination in Step S41, the target value is not input into the target value input box 630, processing operations in Step S42 and Step S43 are skipped, and the processing is ended.

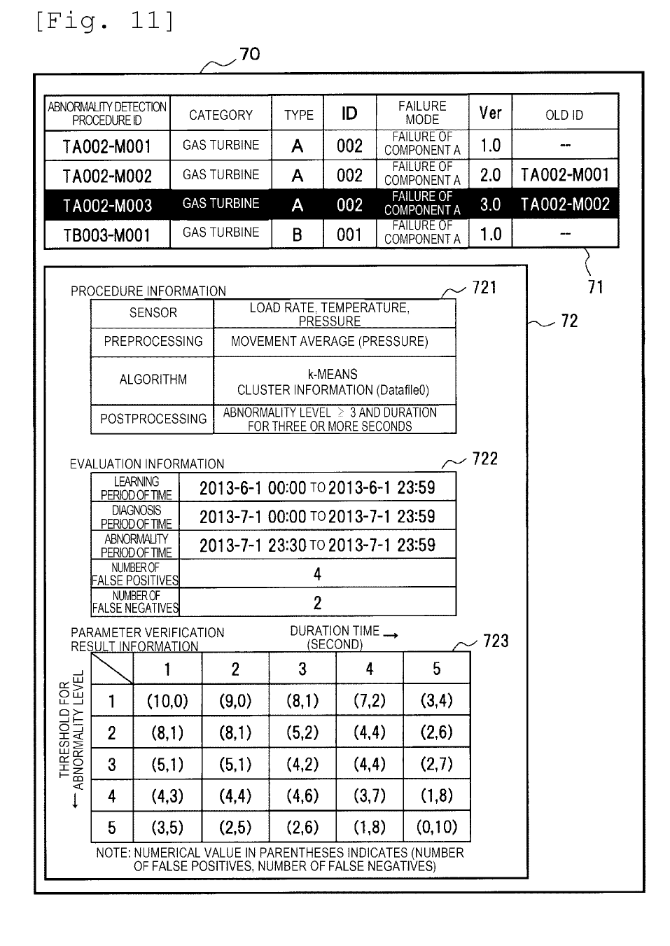

FIG. 10 is a diagram illustrating an example of a flow of processing by the search unit 18. The search unit 18 is activated by clicking on the “past-search” button 622 on the parameter verification screen 60 (refer to FIG. 6). As described in FIG. 10, the search unit 18 first acquires information relating to the mechanical apparatus 1 that is a search target (Step S51). At this point, the information relating to the mechanical apparatus 1 refers to a category, a type, an ID, or the like of the mechanical apparatus 1, and these pieces of information can be acquired from the header information 51 on the abnormality detection procedure development screen 50 (refer to FIG. 5).

Subsequently, the search unit 18 acquires the parameter information on the verification target (Step S52). Specifically, the parameter information can be acquired from the parameter setting table 610 on the parameter verification screen 60.

Next, the search unit 18 searches for information for verifying a similar abnormality detection procedure, referring to the abnormality detection procedure storage unit 11 (Step S53). That is, the search unit 18 extracts a category, a type, and an ID that are included in the header information 111, which are consistent with or similar to those which are included in information on the mechanical apparatus 1 that is the search target, which is acquired in Step S51, and parameter information that is included in the parameter verification result information 114, which is consistent with or similar to the parameter information that is acquired in Step S52, from the abnormality detection procedure information 110 (refer to FIG. 3) that is stored in the abnormality detection procedure storage unit 11.

Then, the search unit 18 displays a result of the search on the display device (Step S54), and ends the processing.

FIG. 11 is a diagram illustrating an example of the search result screen 70 that is displayed by the search unit 18. The search result screen 70 is configured with a similar-mechanical apparatus table 71 and an abnormality detection procedure evaluation information 72. The similar-mechanical apparatus table 71 is a listing of pieces of header information 111 (refer to FIG. 3) in the abnormality detection procedure information 110 (refer to FIG. 3), which are extracted by the search by the search unit 18. It is noted that, when the search result screen 70 is first displayed, only the similar-mechanical apparatus table 71 is displayed.

Next, when the user selects one row (which, in an example in FIG. 11, is a row in which appears as white in a black block) from the similar-mechanical apparatus table 71, the search unit 18 extracts the abnormality detection procedure information 110 that has the header information 111 in which the selected row indicates, referring to the abnormality detection procedure storage unit 11, and displays the procedure information 112, the evaluation information 113, and the parameter verification result information 114, as the abnormality detection procedure evaluation information 72. Therefore, the abnormality detection procedure evaluation information 72 is configured with a procedure information 721, evaluation information 722, and parameter verification result information 723, which are pieces of information that are the same as the procedure information 112, the evaluation information 113, and the parameter verification result information 114, which are illustrated in FIG. 3.

As described above, according to the embodiment of the present invention, it is easy for the expert 5 who is a user of the abnormality detection procedure development apparatus 10 to develop the abnormality detection procedure for the mechanical apparatus 1. Particularly, because a relationship between a value of a parameter that is used for an algorithm for the abnormality detection procedure and the abnormality detection performance can be easily verified, it is possible that a parameter that achieves a maximum abnormality detection performance is selected. That is, the time that it takes to develop the abnormality detection procedure can be shortened. Furthermore, as described above, in selecting a parameter, because the domain knowledge of the expert 5 can be harnessed, it is possible that the abnormality detection procedure is developed in accordance with a situation of the abnormality of the mechanical apparatus 1.

### REFERENCE SIGNS LIST

1 MECHANICAL APPARATUS
2 STATE MONITORING APPARATUS
3 MAINTENANCE ENGINEER
4 ADMINISTRATOR
5 EXPERT
10 ABNORMALITY DETECTION PROCEDURE DEVELOPMENT APPARATUS
11 ABNORMALITY DETECTION PROCEDURE STORAGE UNIT
110 ABNORMALITY DETECTION PROCEDURE INFORMATION
111 HEADER INFORMATION
112 PROCEDURE INFORMATION
113 EVALUATION INFORMATION
114 PARAMETER VERIFICATION RESULT INFORMATION
12 OPERATING DATA STORAGE UNIT
120 OPERATING INFORMATION
121 MACHINE TABLE
122 OPERATING DATA
13 ABNORMALITY DETECTION PROCEDURE EDITING UNIT
14 PARAMETER SETTING UNIT
15 EVALUATION UNIT
16 REFLECTION UNIT
17 PERFORMANCE TARGET VALUE SETTING UNIT
18 SEARCH UNIT
19 DISPLAY UNIT
20 USER INTERFACE
21 COMMUNICATION UNIT
50 ABNORMALITY DETECTION PROCEDURE DEVELOPMENT SCREEN
51 HEADER INFORMATION
52 ABNORMALITY DETECTION PROCEDURE EDITING INFORMATION
53 “REFLECTION” BUTTON
54 “EVALUATION” BUTTON
55 “PARAMETER EVALUATION” BUTTON
521 EDITING-TARGET DATA
522 EVALUATION RESULT DATA
523 PRE-EDITING DATA
524 EDITING-IN-PROGRESS DATA
60 PARAMETER VERIFICATION SCREEN
610 PARAMETER SETTING TABLE
611 “EVALUATION” BUTTON
612 “ADDITION” BUTTON
620 PARAMETER VERIFICATION RESULT TABLE (PERFORMANCE EVALUATION TABLE)
621 “REFLECTION” BUTTON
622 “PAST-SEARCH” BUTTON
630 TARGET VALUE INPUT BOX
70 SEARCH RESULT SCREEN
71 SIMILAR-MECHANICAL APPARATUS TABLE
72 ABNORMALITY DETECTION PROCEDURE EVALUATION INFORMATION
721 PROCEDURE INFORMATION
722 EVALUATION INFORMATION
723 PARAMETER VERIFICATION RESULT INFORMATION

1. An abnormality detection procedure development apparatus, comprising:
a parameter setting unit that sets a parameter verification range that is a range where a value of a parameter is changed, based on data that is input by a user, with respect to the parameter relating to abnormality determination which is included in an abnormality detection procedure for a mechanical apparatus;
an evaluation unit that causes the value of the parameter to be changed in the parameter verification range, and, with respect to each of the values of the parameter that are changed, evaluates an abnormality detection performance of the abnormality detection procedure; and
a display unit on which a performance evaluation table that is a listing of abnormality detection performances which are evaluated by the evaluation unit is displayed with respect to each of the values of the parameter.

2. The abnormality detection procedure development apparatus according to claim 1, further comprising:
a performance target value setting unit that sets a target value of a performance of the abnormality detection procedure, based on data that is input by the user,
wherein, among the abnormality detection performances with respect to the values of the parameter, respectively, which are shown in the performance evaluation table, a box in which an abnormality detection performance that satisfies the target value is shown, is displayed in an emphasized manner, on the display unit.

3. The abnormality detection procedure development apparatus according to claim 1,
wherein an abnormality detection procedure development screen for editing an abnormality detection procedure information that includes information which specifies a mechanical apparatus that is a target for the abnormality detection procedure and a failure mode, and information which specifies a sensor data that is used for the abnormality detection procedure, an algorithm for abnormality detection, and a parameter relating to abnormality determination is further displayed on the display unit.

4. The abnormality detection procedure development apparatus according to claim 3, further comprising:
a reflection unit that selects one box from the performance evaluation table, based on a user's operation input, and that reflects a value of a parameter which corresponds to the selected box, as a value of a parameter that is included in the abnormality detection procedure information of which editing is in progress.

5. The abnormality detection procedure development apparatus according to claim 3, further comprising:
an abnormality detection procedure information storage unit in which the abnormality detection procedure information is stored,
wherein a button indicating that the abnormality detection procedure information of which the editing is in progress is stored in the abnormality detection procedure information storage unit is displayed on the abnormality detection procedure development screen.

6. The abnormality detection procedure development apparatus according to claim 5,
wherein, with respect to an abnormality detection procedure that is designated with the abnormality detection procedure information and a parameter that is included in the parameter verification range, a performance evaluation table that is obtained by evaluation by the evaluation unit is stored in the abnormality detection procedure information storage unit, in a state of being associated with the abnormality detection procedure information.

7. The abnormality detection procedure development apparatus according to claim 6, further comprising:
a search unit that searches the abnormality detection procedure information that is stored in the abnormality detection procedure information storage unit, extracts the performance evaluation table that corresponds to the abnormality detection procedure information similar to the abnormality detection procedure information of which editing is in progress, and displays the extracted performance evaluation table.

8. An abnormality detection procedure development method for a computer that is connected to a state monitoring apparatus of a mechanical apparatus, the computer performing:
parameter setting processing that sets a parameter verification range that is a range where a value of a parameter is changed, based on data that is input by a user, with respect to the parameter relating to abnormality determination which is included in an abnormality detection procedure for the mechanical apparatus;
evaluation processing that causes the value of the parameter to be changed in the parameter verification range, and, with respect to each of the values of the parameter that are changed, evaluates a performance of the abnormality detection procedure; and
display processing that displays a performance evaluation table that is a listing of abnormality detection performances that are evaluated by the evaluation processing, with respect to each of the values of the parameter.

9. The abnormality detection procedure development method according to claim 8,
wherein the computer further performs:
performance target value setting processing that sets a target value of a performance of the abnormality detection procedure, based on data that is input by the user, and
wherein, among the abnormality detection performances with respect to the values of the parameter, respectively, which are shown in the performance evaluation table, a box in which an abnormality detection performance that satisfies the target value is shown, is displayed in an emphasized manner, in the display processing.

10. The abnormality detection procedure development method according to claim 8,
wherein the computer further displays an abnormality detection procedure development screen for editing an abnormality detection procedure information that includes information which specifies a mechanical apparatus that is a target for the abnormality detection procedure and a failure mode, and information which specifies a sensor data that is used for the abnormality detection procedure, an algorithm for abnormality detection, and a parameter relating to abnormality determination, in the display processing.

11. The abnormality detection procedure development method according to claim 10,
wherein the computer further performs:
reflection processing that selects one box from the performance evaluation table, based on a user's operation input, and that reflects a value of a parameter which corresponds to the selected box, as a value of a parameter that is included in the abnormality detection procedure information of which editing is in progress.

12. The abnormality detection procedure development method according to claim 10,
wherein the computer includes an abnormality detection procedure information storage unit in which the abnormality detection procedure information is stored, and
wherein the computer displays a button indicating that the abnormality detection procedure information of which the editing is in progress is stored in the abnormality detection procedure information storage unit, on the abnormality detection procedure development screen.

13. The abnormality detection procedure development method according to claim 12,
wherein, with respect to an abnormality detection procedure that is designated with the abnormality detection procedure information and a parameter that is included in the parameter verification range, a performance evaluation table that is obtained by the evaluation processing is stored in the abnormality detection procedure information storage unit, in a state of being associated with the abnormality detection procedure information.

14. The abnormality detection procedure development method according to claim 13,
wherein the computer further performs:
search processing that searches the abnormality detection procedure information that is stored in the abnormality detection procedure information storage unit, extracts the performance evaluation table that corresponds to the abnormality detection procedure information similar to the abnormality detection procedure information of which editing is in progress, and displays the extracted performance evaluation table.
